(19) United States
(12) Patent Application Publication
(10) Pub. No.: US 2013/0339068 A1
(43) Pub. Date: Dec. 19, 2013

(54) BOARDING INFORMATION REMINDING SYSTEM AND METHOD

(71) Applicant: HON HAI PRECISION INDUSTRY CO., LTD., New Taipei (TW)

(72) Inventors: HOU-HSIEN LEE, New Taipei (TW); CHANG-JUNG LEE, New Taipei (TW); CHIH-PING LO, New Taipei (TW)

(73) Assignee: HON HAI PRECISION INDUSTRY CO., LTD., New Taipei (TW)

(21) Appl. No.: 13/858,048

(22) Filed: Apr. 7, 2013

(30) Foreign Application Priority Data
Jun. 13, 2012 (TW) 101121188

(51) Int. Cl. G06Q 10/02

(52) U.S. Cl. CPC G06Q 10/02
USPC 705/5

(57) ABSTRACT

A boarding information reminding system includes a client system applied in an electronic device and a back-end system applied in a back-end host. the client system receives ticket information and reminder information registered by a client. The back-end system queries up-to-date information of a flight according to the ticket information, and transmits the up-to-date information to the client system. When it is departure time, the client system reminds the client to leave for the airport and continuously transmits position information of the client to the back-end system. The back-end system compares the position information of the client with the position information of the boarding gate, compares current time with the boarding time of the flight, to determine if the client can reach the boarding gate in time. If the client cannot reach the boarding gate in time, the back-end system sends alarm information to the client system.

### BACKGROUND

1. Technical Field

Embodiments of the present disclosure relate to information reminding systems and methods, and more particularly to a boarding information reminding system and method.

2. Description of Related Art

Flight statuses may change after people buy airplane tickets, and information is updated up-to-minute via flight information displayed via billboards or broadcasts of an airport. There are many cases where people who are not at the airport cannot get updated information, and in some cases of where people who are at the airport may not be warned of any flight changes if they are involved in other actions. Therefore, a reminding method is desired.

### BRIEF DESCRIPTION OF THE DRAWINGS

FIG. 1 is a block diagram of one embodiment of function modules of a boarding information reminding system.

FIG. 2 is a block diagram of one embodiment of an application environment of the boarding information reminding system.

FIG. 3 is a flowchart of one embodiment of a boarding information reminding method performed by a client system of the boarding information reminding system shown in FIG. 1.

FIG. 4 is a flowchart of one embodiment of a boarding information reminding method performed by a back-end system of the boarding information reminding system shown in FIG. 1.

FIG. 5A-FIG. 5C and FIG. 6A-FIG. 6B illustrate a client system of the boarding information reminding system shown in FIG. 1.

FIG. 7A-FIG. 7B illustrate reminder information displayed by the client system of the boarding information reminding system shown in FIG. 1.

### DETAILED DESCRIPTION

The present disclosure, including the accompanying drawings, is illustrated by way of examples and not by way of limitation. It should be noted that references to “an” or “one” embodiment in this disclosure are not necessarily to the same embodiment, and such references mean “at least one.”

In general, the word “module”, as used herein, refers to logic embodied in hardware or firmware, or to a collection of software instructions, written in a programming language. One or more software instructions in the modules may be embedded in firmware, such as in an erasable programmable read only memory (EPROM). The modules described herein may be implemented as either software and/or hardware modules and may be stored in any type of non-transitory computer-readable medium or other storage device. Some non-limiting examples of non-transitory computer-readable media include CDs, DVDs, BLU-RAY, flash memory, and hard disk drives.

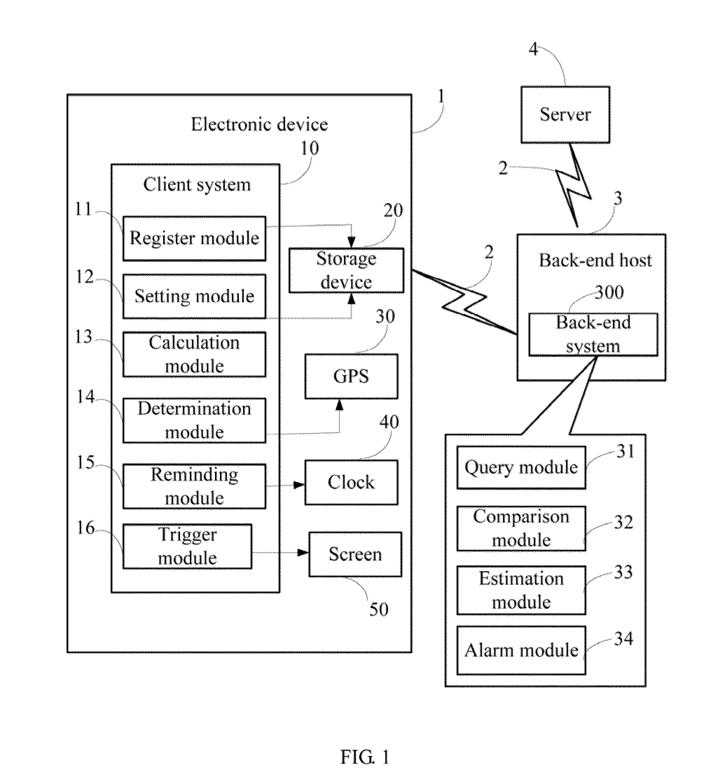

FIG. 1 is a block diagram of one embodiment of function modules of a boarding information reminding system. The boarding information reminding system includes a client system 10 applied in an electronic device 1 and a back-end system 300 applied in a back-end host 3. The electronic device 1 is electronically connected to the back-end host 3 via a network (e.g., local area network, Internet, wireless) 2, and the back-end host 3 is electronically connected to one or more servers 4 (only one shown) of airline companies. The server 4 of an airline company stores up-to-date information of flights of the airline company. In one embodiment, the up-to-date information of each flight includes a takeoff time, a boarding time, a boarding gate of the flight, and global positioning system (GPS) position information of the boarding gate. The electronic device 1 may be a portable computer, a mobile phone, or a personal digital assistant, for example. In this embodiment, the electronic device 1 is a mobile phone. The electronic device 1 further includes a storage device 20, a GPS 30, a clock 40, and a screen 50.

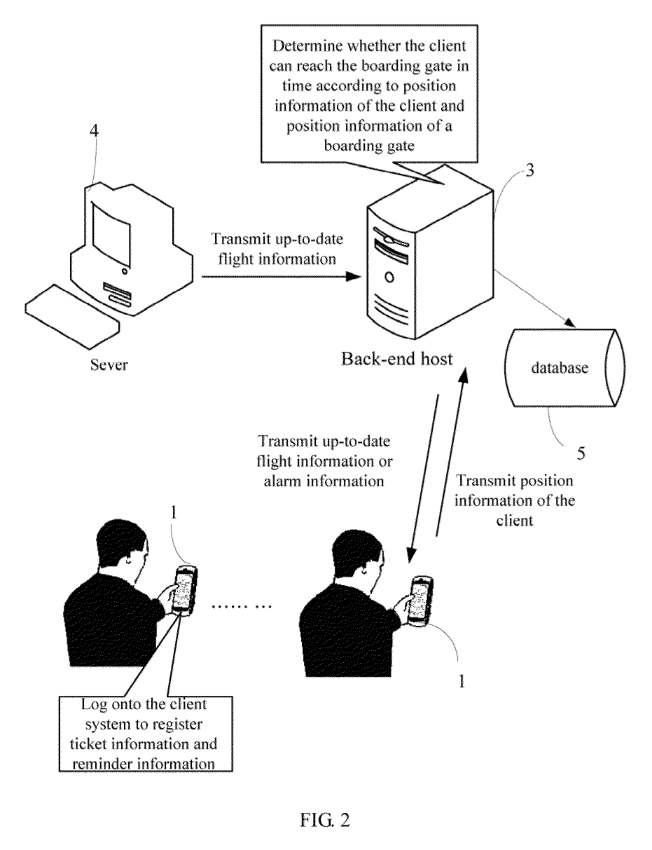

As shown in FIG. 2, the client system 10 in the electronic device 1 receives air ticket information registered by a client, transmits the received information to the back-end host 3. The ticket information includes a flight number, identification information of the client, name information of the client, and a reservation number of the client. The back-end system 300 in the back-end host 3 queries the up-to-date information of a flight associated with the ticket information, such as an updated takeoff time, an updated boarding time, an updated boarding gate of the flight, and GPS position information of the updated boarding gate, stores the up-to-date information in a database 5, and transmits the up-to-date information to the client system 10.

The client system 10 further receives reminder information set by the client. In one embodiment, the reminder information includes a phone number of the electronic device 1, a reminder mode, and a predicted time that would be spent by the client from a departure place to an airport for the flight. The client system 10 determines a departure time for the client according to the predicted time and the boarding time of the flight sent back by the back-end system 300. When it is the departure time, the client system 10 reminds the client to leave for the airport by the reminder mode (such as a voice reminder or vibration), and triggers the GPS 30 to continuously detect position information of the client, and transmits the position information to the back-end system 300.

The back-end system 300 receives the position information of the client, compares the position information of the client with the position information of the boarding gate, compares current time with the boarding time of the flight, to determine if the client can reach the boarding gate in time. If the back-end system 300 determines that the client cannot reach the boarding gate in time (how to determined will be described in below paragraphs), the back-end system 300 sends alarm information to the client system 10 via the network 2. The client system 10 displays the alarm information by the reminder mode on the screen 50.

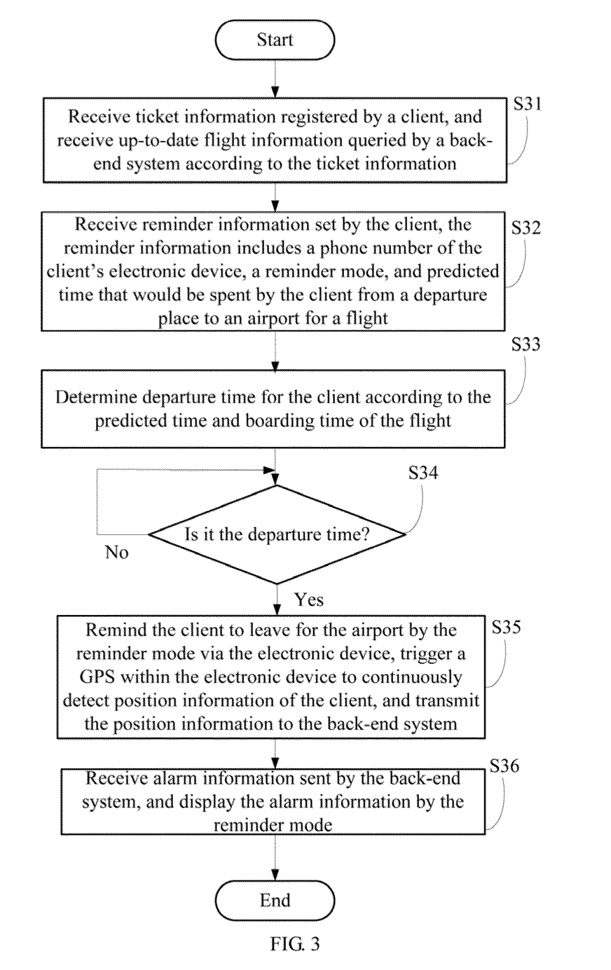

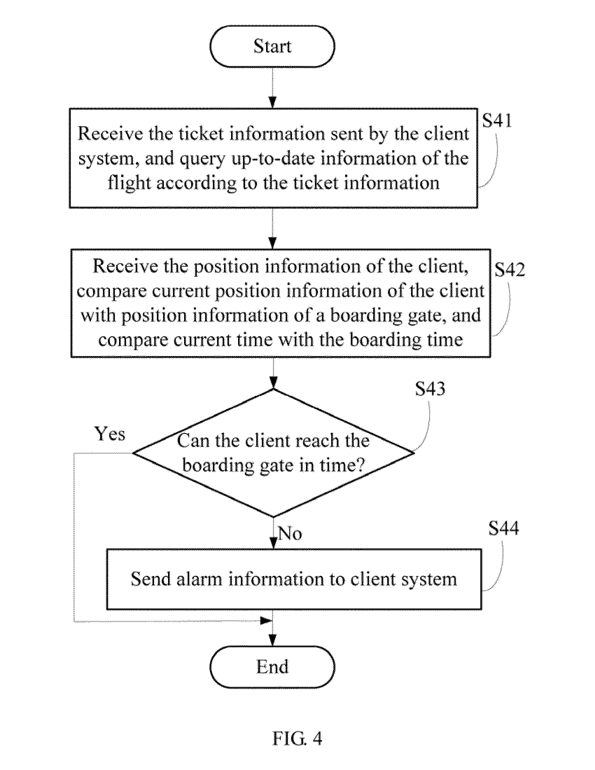

As shown in FIG. 1. the client system 10 includes a register module 11, a setting module 12, a calculation module 13, a determination module 14, a reminding module 15, and a trigger module 16. The back-end system 300 includes a query module 31, a comparison module 32, an estimation module 33, and an alarm module 34. The modules 11-16 and 31-34 comprise computerized code in the form of one or more programs. Computerized code of the modules 11-16 is stored in the storage device 20, a processor (not shown) of the electronic device 1 executes the computerized code to provide the aforementioned functions of the client system 10. Computerized code of the modules 31-34 is stored in a storage device (not shown) of the back-end host 3, a processor (not shown) of the back-end host 3 executes the computerized code to provide the aforementioned functions of the back-end host 3. Detailed functions of the modules 11-16 and 31-34 are referenced in FIG. 3 and FIG. 4.

FIG. 3 is a flowchart of one embodiment of a boarding information reminding method performed by the client system 10. Depending on the embodiment, additional steps may be added, others removed, and the ordering of the steps may be changed.

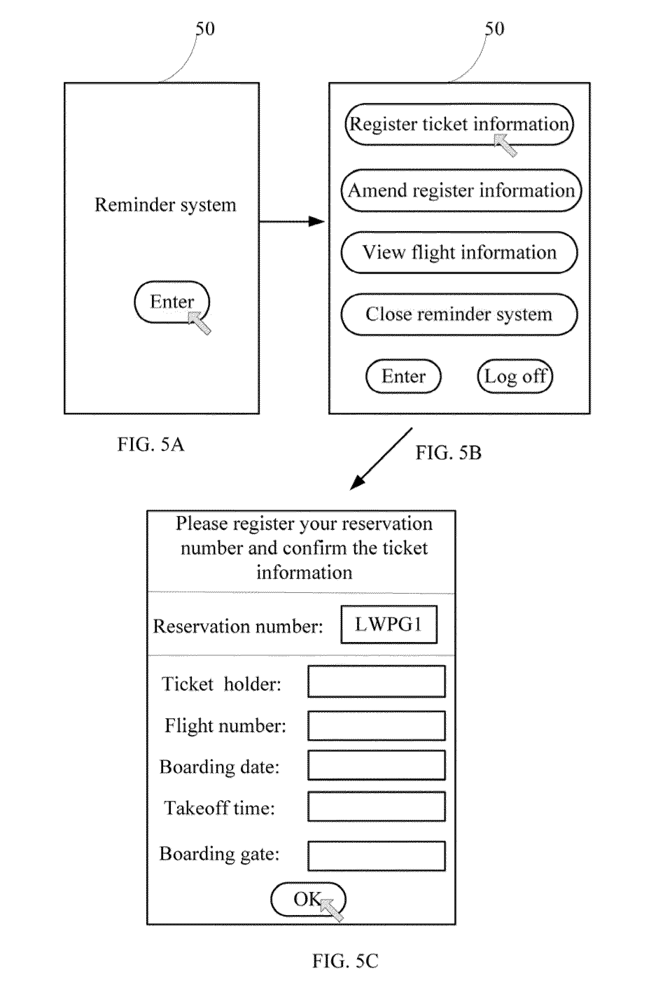

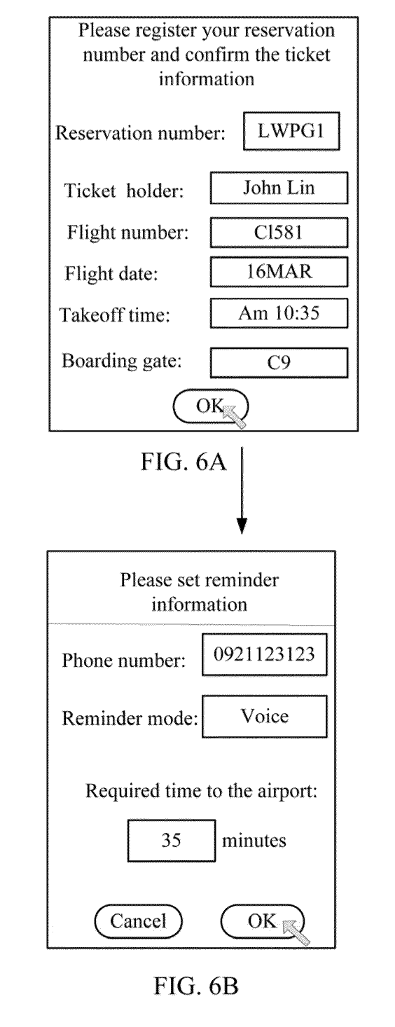

In step S31, the register module 11 receives ticket information of a flight input by a client via an input device (e.g., a keyboard), and receives up-to-date flight information queried by the back-end system 30 according to the ticket information. The ticket information includes identification (ID) and a name of the client, a flight number, and a reservation number, for example. As shown in FIG. 5A, the client may log into the client system 10 (represented by “Reminder system” in FIG. 5A) and select the “Register ticket information” option displayed on the screen 50 as shown in FIG. 5B, and the client system may prompt the client to register the ticket information. In one embodiment, the up-to-date flight information may be queried according to the reservation number. As shown in FIG. 5C, when the client inputs the reservation number (such as “LWPG1”) and confirms the input (such as click an “OK” button displayed on the screen 50), the register module 11 transmits the reservation number to the back-end system 30. The back-end system 30 queries the server 4 about the client information (such as the name and the ID of the client) and the up-to-date flight information according to the reservation number. The up-to-date flight information includes boarding date and takeoff time of the flight, a boarding gate of the flight, and GPS position information of the boarding gate. In other embodiments, the up-to-date flight information may be queried according to the ID or the name of the client. The register module 11 receives the queried information sent by the back-end system 30, and displays the queried information on the screen 50 (as shown in FIG. 6A) for the client to confirm the ticket information.

In step S32, the setting module 12 receives reminder information set by the client. The reminder information includes a phone number of the electronic device 1, a reminder mode, and predicted time that would be spent by the client from a departure place (e.g., home of the client) to an airport for the flight (as shown in FIG. 6B). The setting module store the reminder information into the storage device 20, and transmits the reminder information to the back-end system 30 via the network 2.

In step S33, the calculation module 13 determines departure time for the client according to the predicted time and boarding time of the flight. For example, as shown in FIG. 6A, the flight time is 10:35 AM, if the predicted time is set to be 35 minutes, boarding time of the flight is set to be 20 minutes ahead of the takeoff time, and passengers are required to reach an airport lounge 40 minutes ahead of the boarding time, then the departure time for client is calculated as: 10:35 AM-40 minutes-20 minutes-35 minutes=9:00 AM.

In step S34, the determination module 14 determines if current time of the clock 40 reaches the departure time. If the current time reaches the departure time, step S35 is implemented.

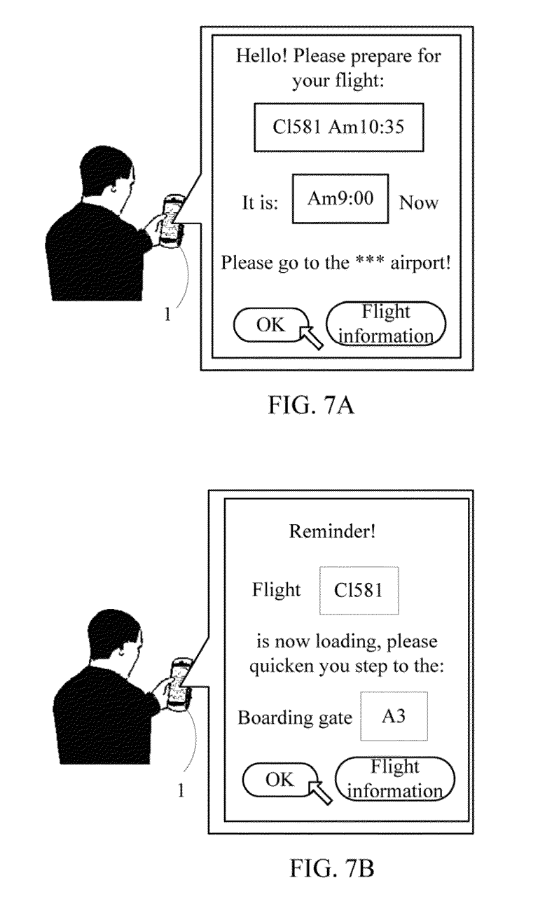

In step S35, the reminding module 15 reminds the client to leave for the airport by the reminder mode (as shown in FIG. 7A). The trigger module 16 triggers the GPS 30 to continuously detect position information of the client, and the GPS 30 transmits the detected position information to the back-end system 300. The back-end system 300 compares the position information of the client and the position information of the boarding gate, and compares the current time and the boarding time, to determine if the client can reach the boarding gate in time. If the client cannot reach the boarding gate in time, the back-end system 30 sends alarm information to the client system 10.

In step S36, the reminding module 15 receives the alarm information sent by the back-end system, and displays the alarm information by the reminder mode (as shown in FIG. 7B).

FIG. 4 is a flowchart of one embodiment of a boarding information reminding method performed by the back-end system 300. Depending on the embodiment, addition steps may be added, others removed, and the ordering of the steps may be changed.

In step S41, the query module 31 receives the ticket information sent by the client system 10, and queries the server 4 for the up-to-date information of the flight according to the ticket information. As mentioned above, the server 4 of an airline company stores up-to-date information of flights of the airline company. After the client bought the air ticket, flight information, such as the takeoff time, the boarding gate, the boarding time, may be changed. The query module 31 sends back the up-to-date information of the flight to the client system 10, so that the client can know latest information of the flight before going to the airport.

In step S42, the comparison module 32 receives current position information of the client sent by the GPS 30, compares the current position information of the client with the position information of the boarding gate, and compares the current time with the boarding time

In step S43, the comparison module 32 determines if the client can reach the boarding gate in time according to the comparison result. For example, the comparison module 32 determines if the client has arrived at the boarding gate by comparing the current information of the client with position information of the boarding gate. In one embodiment, if the current position of the client is the same as the position information of the boarding gate, or if the current position falls within an neighboring area of the boarding gate, the client is determined as arriving at the boarding gate. If the client is determined as have not arriving at the boarding gate, the estimation module 33 estimates a movement speed of the client according to the position information of the client and time of receiving the position information, determines a distance between a current position of the client and the boarding gate. For example, the estimation module 33 may estimate the movement speed according to the current position and a previous position and time for receiving the current position and the previously position. Then, the comparison module determines if the client can reach the boarding gate by the movement speed before the boarding time reaches according to the distance, the current time and the boarding time, and the movement speed. If the client can reach the boarding gate in time, the procedure ends. Otherwise, if the client cannot reach the boarding gate in time, step S44 is implemented.

In step S44, the alarm module 34 generates the alarm information (as shown in FIG. 7B), and sends the alarm information to the client system 10.

Although certain disclosed embodiments of the present disclosure have been specifically described, the present disclosure is not to be construed as being limited thereto. Various changes or modifications may be made to the present disclosure without departing from the scope and spirit of the present disclosure.

What is claimed is:

1. A boarding information reminding method being executed by a processor of an electronic device, the electronic device electronically connected to a back-end host, and the back-end host is electronically connected to a server, the method comprising:
receiving ticket information of a client, and receiving up-to-date flight information of a flight of the client, which is queried from the server by the back-end host according to the ticket information, wherein the up-to-date flight information comprises boarding time, a boarding gate, and position information of the boarding gate;
receiving reminder information set by the client, the reminder information comprising a reminder mode and predicted time that would be spent by the client from a departure place to an airport for the flight;
determining departure time for the client according to the predicted time and the boarding time of the flight;
wherein upon reaching the departure time, reminding the client to leave for the airport by the reminder mode, triggering a global positioning system (GPS) of the electronic device to continuously detect position information of the client, and transmitting the position information to the back-end host, wherein the back-end host determines whether the client can reach the boarding gate in time according to the position information of the client, the position information of the boarding gate, current time, and the boarding time; and
receiving alarm information sent from the back-end host in response to a determination that the client cannot reach the boarding gate in time; and
displaying the alarm information by the reminder mode.

2. The method of claim 1, wherein the ticket information comprises a flight number, identification information, name information, and a reservation number of the client.

3. The method of claim 1, wherein the back-end host determines whether the client can reach the boarding gate in time comprises:
determining if the client has arrived at the boarding gate by comparing the current information of the client with position information of the boarding gate;
if the client is determined as not have arriving at the boarding gate, estimating a movement speed of the client according to the position information of the client and time of receiving the position information, and determining a distance between a current position of the client and the boarding gate; and
determining if the client can reach the boarding gate by the movement speed before the boarding time reaches according to the distance, the current time and the boarding time, and the movement speed.

4. The method of claim 3, wherein the movement speed is estimated according to the current position and a previous position of the client, and time for receiving the current position and the previously position.

5. The method of claim 1, wherein the reminder mode is voice or vibration.

6. A boarding information reminding method being executed by a processor of a back-end host, the back-end host is electronically connected to an electronic device and a server, the method comprising:
receiving ticket information of a client sent by the electronic device, and querying the server for up-to-date information of a flight of the client according to the ticket information, wherein the up-to-date flight information comprises boarding time, a boarding gate and position information of the boarding gate;
receiving current position information of the client sent by a global positioning system (GPS) of the electronic device, and determining whether the client can reach the boarding gate in time according to the position information of the client, the position information of the boarding gate, current time, and the boarding time;
generating alarm information and sending the alarm information to the electronic device, if the client is determined as cannot reach the boarding gate in time.

7. The method of claim 6, wherein the ticket information comprises a flight number, identification information, name information, and a reservation number of the client.

8. The method of claim 6, wherein determining whether the client can reach the boarding gate in time comprises:
determining if the client has arrived at the boarding gate by comparing the current information of the client with position information of the boarding gate;
if the client is determined as not have arriving at the boarding gate, estimating a movement speed of the client according to the position information of the client and time of receiving the position information, and determining a distance between a current position of the client and the boarding gate; and
determining if the client can reach the boarding gate by the movement speed before the boarding time reaches according to the distance, the current time and the boarding time, and the movement speed.

9. The method of claim 8, wherein the movement speed is estimated according to the current position and a previous position of the client, and time for receiving the current position and the previously position.

10. A non-transitory computer-readable medium having stored thereon instructions that, when executed by a processor of an electronic device, causing the electronic device to perform a method for reminding boarding information, the electronic device is electronically connected to a back-end host, and the back-end host is electronically connected to a server, the method comprising:
receiving ticket information of a client, and receiving up-to-date flight information of a flight of the client, which is queried from the server by the back-end host according to the ticket information, wherein the up-to-date flight information comprises boarding time, a boarding gate and position information of the boarding gate;
receiving reminder information set by the client, the reminder information comprising a reminder mode and predicted time that would be spent by the client from a departure place to an airport for the flight;
determining departure time for the client according to the predicted time and boarding time of the flight;
when upon reaching the departure time, reminding the client to leave for the airport by the reminder mode, triggering a global positioning system (GPS) of the electronic device to continuously detect position information of the client, and transmitting the position information to the back-end host, wherein the back-end host determines whether the client can reach the boarding gate in time according to the position information of the client, the position information of the boarding gate, current time and the boarding time; and
receiving alarm information sent from the back-end host in response to a determination that the client cannot reach the boarding gate in time; and
displaying the alarm information by the reminder mode.

11. The medium of claim 10, wherein the ticket information comprises a flight number, identification information, name information, and a reservation number of the client.

12. The medium of claim 10, wherein the back-end host determines whether the client can reach the boarding gate in time comprises:
determining if the client has arrived at the boarding gate by comparing the current information of the client with position information of the boarding gate; and
if the client is determined as not have arriving at the boarding gate, estimating a movement speed of the client according to the position information of the client and time of receiving the position information, and determining a distance between a current position of the client and the boarding gate; and
determining if the client can reach the boarding gate by the movement speed before the boarding time reaches according to the distance, the current time and the boarding time, and the movement speed.

13. The medium of claim 12, wherein the movement speed is estimated according to the current position and a previous position of the client, and time for receiving the current position and the previously position.

14. The medium of claim 10, wherein the reminder mode is voice or vibration.

15. A non-transitory computer-readable medium having stored thereon instructions that, when executed by a processor of a back-end host, causing the back-end host to perform a method for reminding boarding information, the back-end host is electronically connected to an electronic device and a server, the method comprising:
receiving ticket information of a client sent by the electronic device, and querying the server for up-to-date information of a flight according to the ticket information, wherein the up-to-date flight information comprises boarding time, a boarding gate and position information of the boarding gate;
receiving current position information of the client sent by a global positioning system (GPS) of the electronic device, and determining whether the client can reach the boarding gate in time according to the position information of the client and the position information of the boarding gate, current time and the boarding time; and
generating alarm information and sending the alarm information to the electronic device, if the client is determined as cannot reach the boarding gate in time.

16. The medium of claim 15, wherein the ticket information comprises a flight number, identification information, name information, and a reservation number of the client.

17. The medium of claim 15, wherein determining whether the client can reach the boarding gate in time comprises:
determining if the client has arrived at the boarding gate by comparing the current information of the client with position information of the boarding gate;
if the client is determined as not have arriving at the boarding gate, estimating a movement speed of the client according to the position information of the client and time of receiving the position information, and determining a distance between a current position of the client and the boarding gate; and
determining if the client can reach the boarding gate by the movement speed before the boarding time reaches according to the distance, the current time and the boarding time, and the movement speed.

18. The medium of claim 17, wherein the movement speed is estimated according to the current position and a previous position of the client, and time for receiving the current position and the previously position.
